(19) United States
(12) Patent Application Publication
(10) Pub. No.: US 2008/0046665 A1
(43) Pub. Date: Feb. 21, 2008

(54) Multiport Memory Device, Multiprocessor System Including the Same, and Method of Transmitting Data In Multiprocessor System

(76) Inventor: Kyoung-park Kim, Hwaseong-si (KR)

Correspondence Address: F. CHAU & ASSOCIATES, LLC, 130 WOODBURY ROAD, WOODBURY, NY, 11797, US

(21) Appl. No.: 11/745,175

(22) Filed: May 7, 2007

(30) Foreign Application Priority Data
May 24, 2006 (KR) 10-2006-0046541

(51) Int. Cl. G06F 12/00

(52) U.S. Cl. 711/149

(57) ABSTRACT

A multiport memory device includes a first dedicated memory region, a second dedicated memory region, and a shared memory region. The first dedicated memory region can be accessed by a first, processor. The second dedicated memory region can be accessed fay a second processor. The shared memory region can be accessed by both the first processor and the second processor. The shared memory region and comprises an SRAM.

### CROSS-REFERENCE TO RELATED PATENT APPLICATION

This application claims priority to Korean Patent Application No. 10-2006-0046541, filed on May 24, 2006, in the Korean Intellectual Property Office, the disclosure of which is hereby incorporated by reference in its entirety.

### BACKGROUND OF THE INVENTION

1. Technical Field

The present invention relates to a multiprocessor system, and more particularly, to a multiport memory device, a multiprocessor system including the same, and a method of transmitting data in the multiprocessor system.

2. Discussion of the Related Art

DRAMs (dynamic random access memories) perform refresh operations in order to preserve data stored in memory cells. However, the refresh operations consume power, and generally, DRAMs are not used in portable devices that use batteries, such as mobile phones, personal digital assistants (PDAs), or the like. With the advent of 3^{rd} generation wireless applications, it has become common to process large amounts of data in portable devices, which has led to an increase in DRAM usage in portable devices.

Mobile communication devices, such as mobile phones, can be embodied as multiprocessor systems (or multimaster systems) including processors that each perform a particular task. Each processor has a dedicated DRAM which only it can use. However, using dedicated DRAMs may increase the size, complexity, and cost of the entire multiprocessor system. Accordingly, memory devices, which can be commonly accessed (or shared) by the processors, such as a multiport DRAM, are being developed.

FIG. 1 is a block diagram illustrating a multiprocessor system 100 including a conventional multiport DRAM. Referring to FIG. 1, the multiprocessor system 100 includes an application processor 110, a modem 120, a multiport DRAM 130, a central processing unit (CPU) interface 140, a first memory bus 150, and a second memory bus 160.

The application processor 110 processes data for pictures, moving images, or the like, and operates a multimedia device. For example, the application processor 1.10 may control a camera (not shown) or a liquid crystal display (LCD) device (not shown) connected to the application processor 110. The application processor 110 writes data and/or instructions that it has processed to the multiport. DRAM 130 through the first memory bus 150, or reads the data and/or the instructions that it has processed from the multiport DRAM 130. The first memory bus 150 includes a data bus, an address bus, and a control bus. The data bus, address bus, and control bus each transmit signals related to a DRAM interface. The control bus transmits control signals such as clock signals and chip select signals which control data to he transmitted through the data bus.

The modem 120 is a processor which processes code data for communication. The modem 120 may be a baseband processor. The modem writes data and/or instructions that it has processed to the multiport. DRAM 130 through the second memory bus 160, or reads the data and/or instructions that it has processed from the multiport DRAM 130. The second memory bus 160 includes a data bus, an address bus, and a control bus. The data bus, address bus, and control bus each transmit signals related to the DRAM interface.

The multiport DRAM 130 stores data and/or instructions processed by the application processor 110 and the modem 120. The multiport DRAM 130 includes a first dedicated memory region 132, a second dedicated memory region 134, and a shared memory region 136.

The first dedicated memory region 132 is exclusively used by the application processor 110. Only the application processor 110 can access the first dedicated memory region 132. The second dedicated memory region 134 is exclusively used by the modem 120. Only the modem 120 can access the second dedicated memory region 134. The shared memory region 136 can be accessed by both the application processor 110 and the modem 120.

The application processor 110 and the modem 120 may directly exchange data through the CPU interface 140, when they are not using the multiport DRAM 130. However, the data communication speed between the application processor 110 and the modem 120 is relatively slow compared to the data communication speed between the application processor 110 (or the modem 120) and the multiport DRAM 130.

In order for the multiprocessor system 100 to receive/transmit data from/to an external device, the modern 120 may exchange data with the application processor 110 through the shared memory region 136 of the multipart DRAM 130. For example, the application processor 110 may write data for a moving image in the shared memory region 136 of the multiport DRAM 130, and the modem 120 may read the data written in the shared memory region 136 of the multiport DRAM 130.

As the modem 120 starts to read data from the shared memory region 136, if the application processor 110 inputs (or issues) an automatic refresh command to the shared memory region 136, an access conflict may occur due to access priority. The automatic refresh command is a signal for instructing the multiport DRAM 130 to perform an automatic refresh operation during an active operation (for example, a data write operation or a data read operation) of the multiport DRAM 130.

When the automatic refresh operation is not performed, data stored in the shared memory region 136 may be lost. Accordingly, the automatic refresh command has priority over other commands in the multiprocessor system 100. Thus, after performing the automatic refresh operation, the shared memory region 136 may not be able to perform the data read operation of the modern 120.

### SUMMARY OF THE INVENTION

Exemplary embodiments of the present invention provide a multiport memory device in which data is easily transmitted between processors, a multiprocessor system including the same, and a method of transmitting data in the multiprocessor system.

According to an aspect of the present disclosure, a multiport memory device includes a first, dedicated memory region which is accessed by a first processor. A second dedicated memory region is accessed by a second processor. A shared memory region is accessed by both the first processor and the second processor. The shared memory region has a circuit configuration for static random access memory (SRAM).

The first dedicated memory region may have a circuit configuration for dynamic random access memory (DRAM). The second dedicated memory region may have a circuit configuration for DRAM.

The multiport memory device may further include a first protocol converter converting a DRAM interface signal transmitted through a first memory bus and a first port. The first memory bus and the first port are between a memory controller of the first processor and the first dedicated memory region. The DRAM interface signal is converted to an SRAM interface signal. A first protocol selector selects one of the DRAM interface signals and the SRAM interface signal. The DRAM interface signal is provided to the first dedicated memory region or a data signal included in the DRAM interface signal is provided to the memory controller of the first processor. When the memory controller of the first processor accesses the first dedicated memory region and the shared memory region, the SRAM interface signal is provided to the shared memory region or a data signal included in the SRAM interface signal is provided to the first protocol converter. A second protocol converter converts a DRAM interface signal into an SRAM interface signal. The DRAM interface signal is transmitted through a second memory bus and a second port. The second memory bus and the second port are between a memory controller of the second processor and the second dedicated memory region. A second protocol selector selects one of the DRAM interface signal and the SRAM interface signal. The DRAM interface signal is provided to the second dedicated memory region or a data signal included in the DRAM interface signal is provided to the memory controller of the second processor. When the memory controller of the second processor accesses the second dedicated memory region and the shared memory region, the SRAM interface signal is provided to the shared memory region or a data signal included in the SRAM interface signal is provided to the second protocol converter.

According to an aspect of the present disclosure, a multiport memory device includes a first dedicated memory region that stores data processed by a first processor. A second dedicated memory region stores data processed by a second processor. A shared memory region stores data exchanged between the first processor and the second processor. The shared memory region has a circuit configuration for SRAM.

According to an aspect of the present disclosure, a multiprocessor system includes a multiport memory device. The multiport memory device includes a first dedicated memory region, a second dedicated memory region, and a shared memory region. A first processor includes a memory controller that accesses the first dedicated memory region and the shared memory region A second processor includes a memory controller accesses the second dedicated memory region and the shared memory region. The shared memory region stores data exchanged between the first processor and the second processor. The shared region includes a circuit configuration for SRAM.

The memory controller of the first processor may include a first protocol converter which converts a signal into a DRAM interface signal or an SRAM interface signal. The signal is transmitted through a first memory bus and a first port of the multiport memory device. The first memory bus and the first port of the multiport memory device are between a central processing unit (CPU), included in the first processor, the first dedicated memory region and the shared memory region. A first protocol selector selects one of the DRAM interface signal and the SRAM interface signal and provides one of the DRAM interface signal and the SRAM interface signal to the first memory bus. When the memory controller of the first processor accesses the first dedicated memory region and the shared memory region, the first protocol selector may provide a data signal, included in the DRAM interface signal, or the SRAM interface signal, received from the first memory bus, to the first protocol converter. The memory controller of the second processor may include a second protocol converter converting a signal to a DRAM Interface signal or an SRAM interface signal. The signal is transmitted from a second memory bus and a second port of the multiport memory device, which are between a CPU included in the second processor, and the second dedicated memory region and the shared memory region. A second protocol selector selects one of the DRAM interface signal and the SRAM interface signal, and provides one of the DRAM interlace signal and the SRAM interface signal to the second memory bus. When the memory controller of the second processor accesses the second dedicated memory region and the shared memory region, a data signal included in the DRAM interface signal or the SRAM interface signal received from the second memory bus is provided to the second protocol converter.

According to another aspect of the present disclosure, a method of transmitting data in a multiprocessor system includes converting a DRAM interface signal received from a first processor into an SRAM interface signal. A data signal included in the SRAM interface signal is stored in a shared memory region of a multiport memory device. The shared memory region can be accessed by both the first processor and a second processor and has a circuit configuration for SRAM. An address signal and a control signal included in a DRAM interface signal received from the second processor are converted into an SRAM interface signal. The data signal stored in the shared memory region is transmitted to the second processor in response to the SRAM interface signal.

Converting the DRAM interface signal may be performed by a memory controller included in the first processor or the multiport memory device.

The multiport memory device according to an exemplary embodiment of the present invention includes the shared memory region having the SRAM circuit configuration. The automatic refresh operation is not required on the shared memory region. The shared memory region is used in transmitting data between the processor chips. Thus, loss of data during the automatic refresh operation of the multiport DRAM can be prevented, and data can be easily transmitted between the processor chips.

Since the multiprocessor system according to exemplary embodiments of the present invention does not perform the automatic refresh operation in the shared memory region, power consumption can be reduced.

Data of the first processor can be easily transmitted to the second processor through the shared memory region. The shared memory region has an SRAM! circuit configuration which does not perform the automatic refresh operation.

### BRIEF DESCRIPTION OF THE DRAWINGS

The above and other features of the present disclosure will become more apparent by describing in detail exemplary embodiments of the present invention with reference to the attached drawings in which:

FIG. 1 is a block diagram illustrating a multiprocessor system including a conventional multiport DRAM;

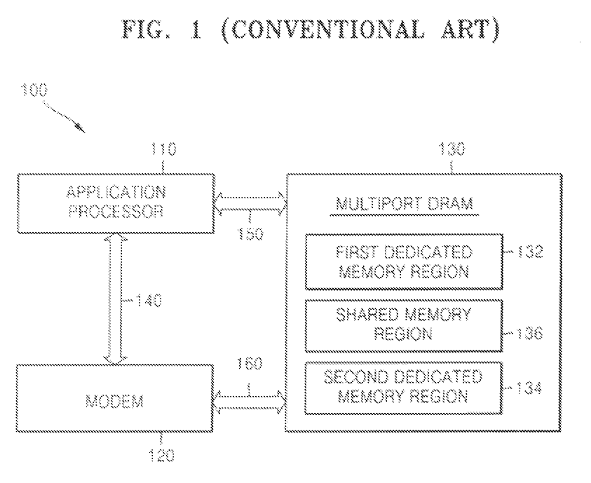

FIG. 2 is a block diagram illustrating a multiprocessor system Including a multiport memory device according to an exemplary embodiment of the present invention; and

FIG. 3 is a block diagram illustrating a multiprocessor system including a

multiport memory device according to an exemplary embodiment of the present invention.

### DETAILED DESCRIPTION OF THE EXEMPLARY EMBODIMENTS

Exemplary embodiments of the present invention will be described more fully with reference to the accompanying drawings. In the drawings, like reference numerals may denote like elements, and the sizes and thicknesses of layers and regions may be exaggerated for clarity.

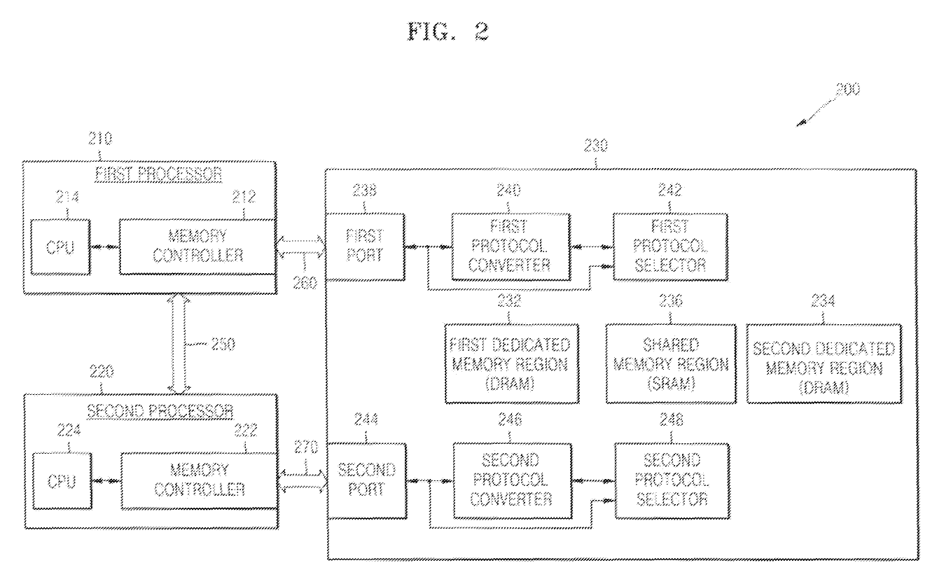

FIG. 2 is a block diagram illustrating a multiprocessor system 200 including a multiport memory device 230 according to an exemplary embodiment of the present invention. Referring to FIG. 2, the multiprocessor system 200 includes a first processor 210, a second processor 220, the multiport memory device 230, a central processing unit (CPU) interface 250, a first memory bus 260, and a second memory bus 270. The multiprocessor system 200 includes a portable device, such as a mobile communication device or a portable computer.

The first processor 210 is a master of the multiport memory device 230, and accesses (writes data to or reads data from) the multiport memory device 230 through the first memory bus 260. The first processor 210 includes a memory controller 212 which controls operations of the multiport memory device 230. The first processor also includes a CPU 214 which controls operations of the memory controller 212. The memory controller 212 accesses a first dedicated memory region 232 and a shared memory region 236 through a first port 238.

The first processor 210, for example, may be an application processor. The application processor processes pictures, moving images, or the like, and operates a multimedia device. For example, the application processor may control a camera (not shown) or an LCD device (not shown) connected to the application processor. The application processor writes or read data and/or instructions that it has processed to the multiport memory device 230 through the first memory bus 260. The width of data received through the first memory bus 260 may be, for example, x16.

The first memory bus 260 includes a data bus, an address bus, and a control bus. The data bus, address bus, and control bus each transmit a DRAM interface signal. The control bus transmits control signals, such as clock signals and chip select signals, which control data to be transmitted through the data bus. The DRAM interface signals include a hi-directional data signal, an address signal, and a control signal (for example, CLK, CKE, RAS, CAS, or WE).

The second processor 220 is a master of the multiport memory device 230 and accesses the multiport memory device 230 through, the second memory bus 270. The second processor 220 includes a memory controller 222, which controls operations of the multiport memory device 230, and a CPU 224 which controls operations of the memory controller 222. The memory controller 222 accesses a second dedicated memory region 234 and the shared memory region 236 through a second port 244.

The second processor 220 may be, for example, a modem, a microprocessor, a digital signal processor, or a baseband processor. The modem is a processor which processes code data for communication. The modem writes or reads data and/or instructions that it has processed to the multiport memory device 230 through the second memory bus 270. The width of data received through the second memory bus 270 may be, for example, x16.

The second memory bus 270 includes a data bus, an address bus, and a control bus. The data bus, address bus, and the control bus each transmit DRAM interface signals.

The multiport memory device 230 stores data and/or instructions processed by the first processor 210 and the second processor 220. The multiport memory device 230 includes the first dedicated memory region 232, the second dedicated memory region 234, the shared memory region 236, the first port 238, a first protocol converter 240, a first protocol selector 242, the second port 244, a second protocol converter 246, and a second protocol selector 248.

As illustrated in FIG. 2, the first dedicated memory region 232, the shared memory region 236, and the second dedicated memory region 234 may be disposed adjacent to each other or contacting each other. Based on the disposition, a signal line and a power supply line used while a memory device operates can be shared.

The first dedicated memory region 232 is used (for example, accessed) by the first processor 210. The first processor 210 can access the first dedicated memory region 232. The first dedicated memory region 232 has a circuit configuration for a semiconductor memory device such as DRAM, which performs an automatic refresh operation. For example, the first dedicated memory region 232 may be embodied as two memory banks each having a data storage capacity of 128 Mb.

The second dedicated memory region 234 is used by the second processor 220. The second processor 220 can access the second dedicated memory region 234. The second dedicated memory region 234 has a circuit configuration for a semiconductor memory device such as DRAM, which performs an automatic refresh operation. For example, the second dedicated memory region 234 may include one memory bank having a data storage capacity of 128 Mb.

The shared memory region 236 can be accessed by both the first processor 210 and the second processor 220. The shared memory region 236 stores data exchanged between the first processor 210 and the second processor 220 among data processed by the first processor 210 and the second processor 220. The shared memory region 236 has a circuit configuration for a semiconductor memory device, for example, a static random access memory (SRAM), which does not perform an automatic refresh operation. For example, the data exchanged between the first processor 210 and the second processor 220 can occur within a part of the shared memory region 236. The shared memory region 236 may include one memory bank having a data storage capacity of 128 Mb.

As described above, the multiport memory device 230 is a fusion memory, wherein the circuit configurations of the first and second dedicated memory regions 232 and 234 and the circuit configuration of the shared memory region 236 are different. For example, the SRAM included in the shared memory region 236 might not include a bit line sense amplifier, whereas the DRAMs included in the first and second dedicated memory regions 232 and 234 include bit line sense amplifiers.

When the first processor 210 and the second processor 220 do not use the multiport memory device 230, the first processor 210 and the second processor 220 may directly exchange data through the CPU interface 250. However, the data communication speed between the first and second processors 210 and 220 (for example, 500 Kbps) is relatively slow compared to the data communication speed between the first processor 210 (or the second processor 220) and the multiport memory device 230 (for example, 133 Mbps).

The first protocol converter 240 converts a DRAM interface signal to an SRAM interface signal. The DRAM interface signal is transmitted through the first memory bus 260 and the first port 238, which are between the memory controller 212 of the first processor 210 and the first dedicated memory region 232.

The SRAM interface signal might not include a row address strobe signal (RAS) for indicating that a row address signal is being applied, nor a column address strobe signal (CAS) for indicating that a column address signal is being applied. However, the DRAM interface signal includes the RAS and the CAS. The SRAM interface signals include a bi-directional data signal, an address signal, and a control signal (for example, CLK or RE/WE).

When the memory controller 212 of the first processor 210 accesses the first dedicated memory region 232 and the shared memory region 236, the first protocol selector 242 selects the DRAM interface signal or the SRAM interface signal. The first protocol selector 242 provides the DRAM interface signal to the first dedicated memory region 232 or provides a data signal included in the DRAM interface signal to the memory controller 212 of the first processor 210. Also, the first protocol selector 242 provides the SRAM interface signal to the shared memory region 236 or provides a data signal included in the SRAM interface signal to the first protocol converter 240.

Operations of the first protocol converter 240 and the first protocol selector 242 are controlled by the memory controller 212 of the first processor 210.

The second protocol converter 246 converts a DRAM interface signal to an SRAM interface signal. The DRAM interface signal is transmitted through the second memory bus 270 and the second port 244, which are between the memory controller 222 of the second processor 220 and the second dedicated memory region 234. The DRAM interface signals include a bi-directional data signal, an address signal, and a control signal (for example, CLK, CKE, RAS, CAS, or WE), and the SRAM interface signals include a bi-directional data signal, an address signal, and a control signal (for example, CLK or RE/WE).

When the memory controller 222 of the second processor 220 accesses the second dedicated memory region 234 and the shared memory region 236 the second protocol selector 248 selects the DRAM interlace signal or the SRAM interface signal. The second protocol selector 248 provides the DRAM interface signal to the second dedicated memory region 234 or provides a data signal included in the DRAM interlace signal to the memory controller 222 of the second processor 220. The second protocol selector 248 provides the SRAM interface signal to the shared memory region 236 or provides a data signal included in the SRAM interface signal to the second protocol converter 246.

Operations of the second protocol converter 246 and the second protocol selector 248 may be controlled by the memory controller 222 of the second processor 220.

As described above, since the multiport memory device 230 of the multiprocessor system 200 according to the current embodiment of the present invention includes the shared memory region 236 having the circuit configuration for SRAM, an automatic refresh operation on the shared memory region 236 used for transmitting data between processor chips is not required. Accordingly, loss of data during the automatic refresh operation of the multiport DRAM can be prevented, and the data can be easily transmitted between the processor chips.

Also, since the multiprocessor system 200 does not perform the automatic refresh operation on the shared memory region 236, power consumption can be reduced.

In FIG. 2, the multiprocessor system 200 is a 2-processor system, but the multiprocessor system 200 may have three or more processors.

The 3-processor system includes three processors and a three port memory device which can be accessed by the three processors. The three port memory device may include three dedicated memory regions and one shared memory region. Operations of the 3-processor system are similar to the operations of the 2-processor system as described in FIG. 2.

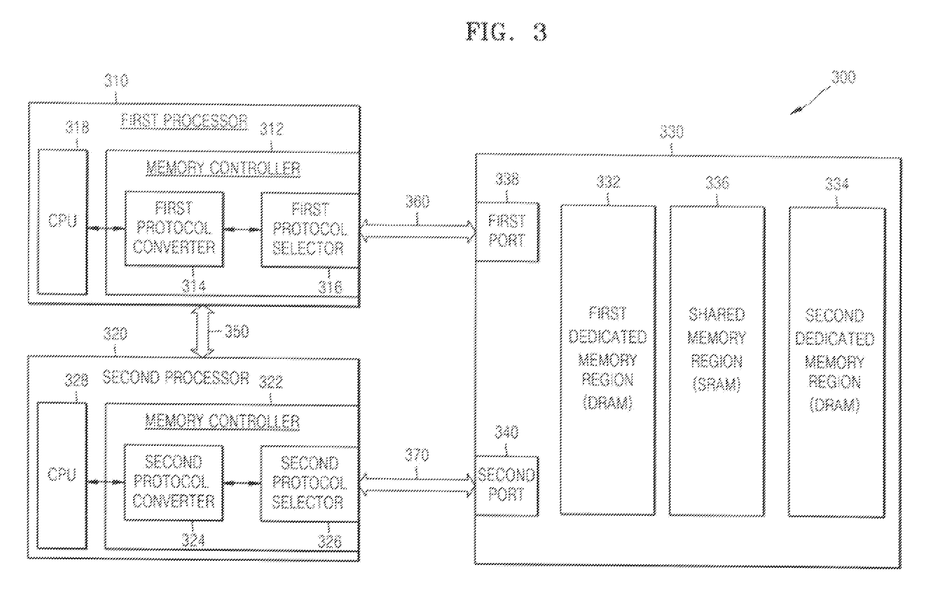

FIG. 3 is a block diagram Illustrating a multiprocessor system 300 including a multiport memory device 330 according to an exemplary embodiment of the present invention. Referring to FIG. 3, the multiprocessor system 300 includes a first processor 310, a second processor 320, the multiport memory device 330, a CPU interface 350, a first memory bus 360, and a second memory bus 370. The multiprocessor system 300 includes a portable device, such as a mobile communication device or a portable computer.

The first processor 310 is a master of the multiport memory device 330, and accesses (writes data to or reads data from) the multiport memory device 330 through the first memory bus 360. The first processor 310 includes a memory controller 312 which controls operations of the multiport memory device 330, and a CPU 318 which controls operations of the memory controller 312. The memory controller 312 accesses a first dedicated memory region 332 and a shared memory region 336 through a first port 338.

The first processor 310, for example, may be an application processor. The application processor processes pictures, moving images, or the like, and operates a multimedia device. For example, the application processor may control a camera (not shown) or an LCD device (not shown) connected to the application processor. The application processor writes or reads data and/or instructions that it has processed to the multiport memory device 330 through the first memory bus 360. The width of the data, received through the first memory bus 360 may be, for example, x16.

The first memory bus 360 includes a data bus, an address bus, and a control bus. The data bus, address bus, and control bus each transmit DRAM interlace signals or SRAM interface signals The control bus transmits control signals, such as clock signals and chip select signals, which control data to be transmitted through the data bus. The DRAM interface signals include a bi-directional data signal, an address signal, and a control signal (for example, CLK, CKE, RAS, CAS, or WE). The SRAM interface signals include a bi-directional data signal, an address signal, and a control signal (for example, CLK or RE/WE).

The memory controller 312 includes a first protocol converter 314 and a first protocol selector 316. The first protocol converter 314 converts a signal into a DRAM interlace signal or an SRAM interface signal. The signal is transmitted (or communicated) through the first memory bus 360 and the first port 338. The first memory bus 360 and the first port 338 are between the CPU 318, and the first dedicated memory region 332 and the shared memory region 336.

When the memory controller 312 of the first processor 310 accesses the first dedicated memory region 332 and the shared memory region 336, the first protocol selector 316 selects the DRAM interface signal or the SRAM interface signal. The first protocol selector 316 provides the DRAM interface signal or the SRAM interface signal to the first memory bus 360. The first protocol selector 316 provides a data signal included in the DRAM interface signal or the SRAM interface signal received from the first memory bus 360 to the first, protocol converter 314.

Operations of the first protocol converter 314 and the first protocol selector 316 are controlled by the memory controller 312 of the first processor 310.

The second processor 320 is a master of the multiport memory device 330 and accesses the multiport memory device 330 through the second memory bus 370. The second processor 320 includes a memory controller 322, which controls operations of the multiport memory device 330, and a CPU 328 which controls operations of the memory controller 322. The memory controller 322 accesses a second dedicated memory region 334 and the shared memory region 336 through a second port 340.

The second processor 320 may be, for example, a modem, a microprocessor, a digital signal processor, or a baseband processor. The modem is a processor which processes code data for communication. The modem writes or reads data and/or instructions that it has processed to the multiport memory device 330 through the second memory bus 370. The width of the data received through the second memory bus 370 may be, for example, x16.

The second memory bus 370 includes a data bus, an address bus, and a control bus. The data bus, address bus, and control bus each transmit DRAM interface signals or SRAM interface signals.

The memory controller 322 includes a second protocol converter 324 and a second protocol selector 326. The second protocol converter 324 converts a signal to a DRAM interface signal or an SRAM interface signal. The signal is transmitted through the second memory bus 370 and the second port 340, which are between the CPU 328, and the second dedicated memory region 334 and the shared memory region 336.

When the memory controller 322 of the second processor 320 accesses the second dedicated memory region 334 and the shared memory region 336 the second protocol selector 326 selects the DRAM interface signal or the SRAM interface signal. The second protocol selector 326 provides the DRAM interface signal or the SRAM interface signal to the second memory bus 370. The second protocol selector 326 provides a data signal from the second memory bus 370 to the second protocol converter 324. The data bus signal is included in the DRAM interface signal or the SRAM interface signal.

Operations of the second protocol converter 324 and the second protocol selector 326 are controlled by the memory controller 322 of the second processor 320.

The multiport memory device 330 stores data and/or instructions processed by the first processor 310 and the second processor 320. The multiport memory device 330 includes the first dedicated memory region 332, the second dedicated memory region 334, the shared memory region 336, the first port 338, and the second port 340.

As illustrated in FIG. 3, the first dedicated memory region 332, the shared memory region 336, and the second dedicated memory region 334 may be disposed adjacent to each other or contacting each other. Based on the disposition, a signal line and a power supply line used while the memory device operates can be shared.

The first dedicated memory region 332 is used (or accessed) by the first processor 310. The first processor 310 can access the first dedicated memory region 332. The first dedicated memory region 332 has a circuit configuration for a semiconductor memory device such as DRAM, which performs an automatic refresh operation. For example, the first dedicated memory region 332 can be embodied as two banks each having a data storage capacity of 128 Mb.

The second dedicated memory region 334 is used by the second processor 320. The second processor 320 can access the second dedicated memory region 334. The second dedicated memory region 334 has a circuit configuration for a semiconductor memory device such as DRAM, which performs an automatic refresh operation. For example, the second dedicated memory region 334 may include one memory bank having a data storage capacity of 128 Mb.

The shared memory region 336 can be accessed by both the first processor 310 and the second processor 320. The shared memory region 336 stores data exchanged between the first processor 310 and the second processor 320 among data processed in the first processor 310 and the second processor 320. The shared memory region 336 has a circuit configuration for a semiconductor memory device such as SRAM, which does not perform an automatic refresh operation. The data exchanged between the first processor 310 and the second processor 320 can be exchanged through a part of the shared memory region 336. The shared memory region 336 may include one memory bank having a data storage capacity of 128 Mb.

As described above, the multiport memory device 330 according to an exemplary embodiment of the present invention is a fusion memory. The circuit configurations of the first and second dedicated memory regions 332 and 334 are different from the circuit configuration of the shared memory region 336.

When the first processor 310 and the second processor 320 do not use the multiport memory device 330, the first processor 310 and the second processor 320 can directly exchange data through the CPU interface 350. However, the data communication speed between the first processor 310 and the second processor 320 is relatively slow compared to the data communication speed between the first processor 310 (or the second processor 320) and the multiport memory device 330.

As described above, since the multiport memory device 330 of the multiprocessor system 300 includes the shared memory region 336 having the circuit, configuration for SRAM, an automatic refresh operation on the shared memory region 336 used for transmitting data between processor chips is not required. Accordingly, loss of data during the automatic refresh operation of the multiport DRAM can he prevented, and the data can be easily transmitted between the processor chips.

Since the multiprocessor system 300 does not perform the automatic refresh operations on the shared memory region 336, power consumption can be reduced.

In FIG. 3, the multiprocessor system 300 is a 2-processor system, but the multiprocessor system 300 may have three or more processors.

The 3-processor system includes three processors and a three port memory device which can be accessed by the three processors. The three port memory device may include three dedicated memory regions and one shared memory region. Operations of the 3-processor system are similar to the operations of the 2-processor system as described in FIG. 3.

A method of transmitting data in the multiprocessor system according to an exemplary embodiment of the present invention will be described. The method can be used in the multiprocessor system 200 illustrated in FIG. 2, the multiprocessor system 300 illustrated in FIG. 3, or another multiprocessor system.

In a first conversion step, a DRAM interface signal, transmitted from a first processor, is converted into an SRAM interface signal. The DRAM interface signals include a bi-directional data signal, an address signal, and a control signal (for example, CLK, CKE, RAS, CAS, or WE). The SRAM interface signals include a bi-directional data signal, an address signal, and a control signal (for example, CLK or RE/WE).

The first conversion step can be performed by a memory controller included in the first processor or a multiport memory device which is accessed by the first processor. The first processor may be an application processor.

In a storing step, a data signal included in the SRAM interface signal is stored in a shared memory region of the multiport memory device. The shared memory region can be accessed by both the first processor and a second processor, and has a circuit configuration for SRAM which does not perform an automatic refresh operation.

In a second conversion step, an address signal and a control signal included in a DRAM interface signal transmitted from the second processor are converted into SRAM interface signals. The second conversion step can be performed by a memory controller included in the second processor or the multiport memory device which is accessed by the second processor. The second processor may be a modem.

In a transmission step, the data signal stored in the shared memory region is transmitted to the second processor in response to the SRAM interface signal of the second conversion step.

Accordingly, data of the first processor can be easily transmitted to the second processor using the shared memory region having the circuit configuration for SRAM which does not perform an automatic refresh operation.

While the present disclosure has been particularly shown and described with reference to exemplary embodiments of the present invention, it will be understood by those of ordinary skill in the art that various changes in form and details may be made without departing from the spirit and scope of the present invention.

What is claimed is:

1. A multiport memory device comprising:
a first dedicated memory region accessed by a first processor;
a second dedicated memory region accessed by a second processor; and
a shared memory region accessed by the first processor and the second processor,
wherein the shared memory region comprises a static random access memory (SRAM).

2. The multiport memory device of claim 1, wherein the first dedicated memory region comprises a dynamic random access memory (DRAM).

3. The multiport memory device of claim 2, wherein the second dedicated memory region comprises a DRAM.

4. The multiport memory device of claim 3, further comprising:
a first protocol converter converting a DRAM interface signal, transmitted through a first memory bus and a first port into an SRAM interface signal, the first memory bus and the first port being between a memory controller of the first processor and the first dedicated memory region;
a first protocol selector selecting either the DRAM interface signal or the SRAM interface signal, either providing the DRAM interface signal to the first dedicated memory region or providing a data signal included in the DRAM interface signal to the memory controller of the first processor, and providing the SRAM interface signal to either the shared memory region or a data signal included in the SRAM interface signal to the first protocol converter, when the memory controller of the first processor accesses the first dedicated memory region and the shared memory region;
a second protocol converter converting a DRAM interface signal, transmitted through a second memory bus and a second port into an SRAM interface signal, the second memory bus and the second port being between a memory controller of the second processor and the second dedicated memory region; and
a second protocol selector selecting either the DRAM interface signal or the SRAM interface signal, providing the DRAM interface signal to either the second dedicated memory region or a data signal included in the DRAM interface signal to the memory controller of the second processor, and either providing the SRAM interface signal to the shared memory region or providing a data signal included in the SRAM interface signal to the second protocol converter, when the memory controller of the second processor accesses the second dedicated memory region and the shared memory region.

5. The multiport memory device of claim 4, wherein the first dedicated memory region, the shared memory region, and the second dedicated memory region are adjacent to each other.

6. The multiport memory device of claim 5, wherein the first processor is an application processor and the second processor is a modem.

7. A multiport memory device comprising:
a first dedicated memory region storing data processed by a first processor;
a second dedicated memory region storing data processed by a second processor; and
a shared memory region storing data exchanged between the first processor and the second processor,
wherein the shared memory region comprises an SRAM.

8. The multiport memory device of claim 7, wherein the first dedicated memory region comprises a DRAM.

9. The multiport memory device of claim 8, wherein the second dedicated memory region comprises a DRAM.

10. A multiprocessor system comprising:
a multiport memory device comprising a first dedicated memory region, a second dedicated memory region, and a shared memory region;
a first processor comprising a memory controller accessing the first dedicated memory region and the shared memory region; and
a second processor comprising a memory controller accessing the second dedicated memory region and the shared memory region,
wherein the shared memory region comprises an SRAM and the shared memory region stores data exchanged between the first processor and the second processor.

11. The multiprocessor system of claim 10, wherein the memory controller of the first processor comprises:
a first protocol converter converting a signal, transmitted through a first memory bus and a first port of the multiport memory device, into a DRAM interface signal or an SRAM interface signal, wherein the memory bus and the first port of the multiport memory device are between a central processing unit (CPU) included in the first processor, and the first dedicated memory region and the shared memory region; and
a first protocol selector selecting either the DRAM interface signal or the SRAM interface signal, and providing either the DRAM interface signal and the SRAM interface signal to the first memory bus or providing a data signal included in the DRAM interface signal or the SRAM interface signal received from the first memory bus to the first protocol converter, when the memory controller of the first processor accesses the first dedicated memory region and the shared memory region, and
wherein the memory controller of the second processor comprises:
a second protocol converter converting a signal, transmitted from a second memory bus and a second port of the multiport memory device into a DRAM interface signal or an SRAM interface signal, wherein the second memory bus and the second port of the multiport memory are between a CPU included in the second processor, and the second dedicated memory region and the shared memory region; and
a second protocol selector selecting either the DRAM interface signal or the SRAM interface signal, and providing the DRAM interface signal or the SRAM interface signal to the second memory bus or providing a data signal included in the DRAM interface signal or the SRAM interface signal received from the second memory bus to the second protocol converter, when the memory controller of the second processor accesses the second dedicated memory region and the shared memory region.

12. The multiprocessor system of claim 11, wherein the first dedicated memory region, the shared memory region, and the second dedicated memory region are adjacent to each other.

13. The multiprocessor system of claim 12, wherein the first processor is an application processor and the second processor is a modem.

14. A method of transmitting data in a multiprocessor system, the method comprising:
converting a DRAM interface signal received from a first processor into a first SRAM interface signal;
storing a data signal included in the first SRAM interface signal in a shared memory region of a multiport memory device accessible by both the first processor and a second processor, wherein the multiport memory device comprises an SRAM;
converting an address signal and a control signal included in a DRAM interface signal received from the second processor into a second SRAM interface signal; and
transmitting the data signal stored In the shared memory region to the second processor in response to the second SRAM interface signal.

15. The method of claim 14, wherein the step of converting the DRAM interface signal is performed by a memory controller included in the first processor or the multiport memory device.

16. The method of claim 14, wherein the step of converting the address and control signal is performed by a memory controller included in either the second processor or the multiport memory device.

17. The method of claim 14, wherein the first processor is an application processor and the second processor is a modem.
